(19) United States
(12) Patent Application Publication
(10) Pub. No.: US 2018/0225718 A1
(43) Pub. Date: Aug. 9, 2018

(54) USER-SPECIFIC PROMOTION UNIT FOR PAGE ADVERTISEMENTS

(71) Applicant: Facebook, Inc., Menlo Park, CA (US)

(72) Inventors: Ahmed Magdy Hamed Mohamed, Seattle, WA (US); Jinyi Yao, Issaquah, WA (US)

(21) Appl. No.: 15/428,140

(22) Filed: Feb. 8, 2017

(51) Int. Cl. G06Q 30/02; G06N 99/00

(52) U.S. Cl. CPC G06Q 30/0269; G06N 99/005; G06Q 30/0261; G06Q 30/0249

(57) ABSTRACT

A online system generates and displays page promotion units to viewing users of the online system. The page promotion unit provides content to the viewing user to promote advertisement of a page that the viewing user administers or advertises for. The page promotion unit may be dynamically generated based on content of the page that the viewing user administers. The page promotion unit may also include suggested operational parameters for a campaign to display the content, which may include budget or suggested targeting criteria, as well as estimated reach for the campaign. The page promotion unit also provides an interface for the viewing user to promote the page and direct the viewing user to an interface for initiating an advertising campaign for the page, which may be prepopulated with content from the page promotion unit.

### BACKGROUND

This invention relates generally to selecting and generating content for display on an online system, and particularly to generating content for promotion of a page associated with a user.

In an online system, users may administer or advertise pages within the online system. For example, a user may be a manager of a brand or page related to a business, interest, or other type of page. These users may also promote the page using advertisements within the online system, for example to encourage other users to visit the user's page. However, many of these pages may be infrequently advertised by page administrators, and page administrators may neglect to advertise such pages. In addition, page administrators may struggle with identifying how to advertise for the page and what content for a page to include in an advertisement or what parameters to place on an advertisement for the page.

### SUMMARY

An online system promotes page advertisements in a feed of stories and other content for a user of the online system that owns, administers, or previously advertised a page (a “page administrator”). The online system generates a page promotion unit to promote page advertisement to an owner or administrator for a page. The page promotion unit incorporates content items or other data from the page to display a possible advertisement to the user having a role as an administrator for the page. The page promotion unit thus provides information to the page administrator indicating a possible advertisement for the page administrator to use in an advertisement to promote the page. When a user interacts with the page promotion unit, the user is directed to an ad creation page for generating an advertising campaign for the page. The ad creation page may be prepopulated with advertising content from the page creation unit. From the page administrator's perspective, this provides a reminder to advertise the page and a prepopulated advertisement for the advertiser to use in the page.

The online system may also generate operational parameters for the viewing user to use in promoting content of the page. The operational parameters may be suggested for the suggested advertising content, or may suggest promoting other interaction with a page by other users, such as presentation or engagement with existing page content. The operational parameters describe characteristics of a campaign to promote the page, such as a budget or target audience for the campaign. The expected reach (estimated users to view or interact with the campaign content) given the operational parameters may also be presented. This provides additional information and ease for the page administrator to understand the cost and impact of the suggested campaign and can automatically populate (or implement) a campaign. A computer model generates the suggested operational parameters for the campaign based on characteristics of the user and the page to be promoted. To provide a budget, the computer model may analyze the user's characteristics relating to the user's prior promotions of the page and prior campaigns authorized by that user. This may permit budget and reach to reflect that user's own requested campaigns rather than other user's placements promoting the page. The suggested target audience may be based on characteristics of the page or the page's audience. In this way, the operational parameters for the suggested campaign in some embodiments may reflect both user-specific and page-specific characteristics, so that the operational parameters for the campaign are automatically tailored to the user and the promoted by the user.

To display the page promotion unit, the online system receives a request from a viewing user for content, for example on a main page of the online system or on another page accessed by a user. The online system determines whether that user is associated with a page as a page administrator to determine whether the user is eligible for a page promotion unit for the page that the user administers. When the user is associated with a page as a page administrator, the page promotion unit may be eligible for presentation to the user. In some embodiments, the page promotion unit competes with other content types for presentation to the user in the feed. The other types of content may be advertisements to the user or various recommendation units for an action of the user to take in the online system. To compete against these different units, the online system determines an expected value of providing the page promotion unit, and the page promotion unit competes against the different content types in an auction to determine which of these to present to the user. In other embodiments, the page promotion unit is presented to the user without competing for placement, and may be presented in other locations than a newsfeed. For example, the promotion unit may be presented as a notification or on an interface for viewing engagement with the promoted page.

When the page promotion unit is to be presented to the viewing user, the online system determines the content of the page promotion unit. The content may be based on the content of the page administered by the promoted by the page promotion unit and incorporate content items and descriptions of the page. The page promotion unit may be determined based on the content of the page, and may further be determined based on the viewing user's previous actions advertising the page or other pages, as well as the viewing user's interactions with content on the page. In addition and alternatively, the page promotion unit may also propose operational parameters for a campaign. In these ways, a page promotion unit may be generated for a viewing user that is dynamic and related to the viewing user and the actual content campaigns likely to be initiated by the viewing user. When a user elects to place the campaign from the promotional unit, the suggested operational parameters may be used to automatically begin the campaign with the operational parameters, or the viewing user may initiate a campaign creation flow that initially specifies the suggested operational parameters and may be subsequently modified before initiating the campaign.

### BRIEF DESCRIPTION OF THE FIGURES

FIG. 1 is a high level block diagram of a system environment for an online system, according to one embodiment.

FIG. 2 illustrates a sample user interface of a feed of stories including a page promotion unit, according to one embodiment.

FIG. 3 illustrates a sample flow for displaying a page promotion unit and initiating an advertising campaign from the page promotion unit, according to one embodiment.

FIG. 4 illustrates a sample user interface of a feed of stories including a page promotion unit according to one embodiment.

FIGS. 5A-5C illustrate sample user interfaces for page promotion units according to additional embodiments.

FIG. 6 illustrates a sample flow for displaying a page promotion unit and initiating an advertising campaign from the page promotion unit, according to one embodiment.

### DETAILED DESCRIPTION

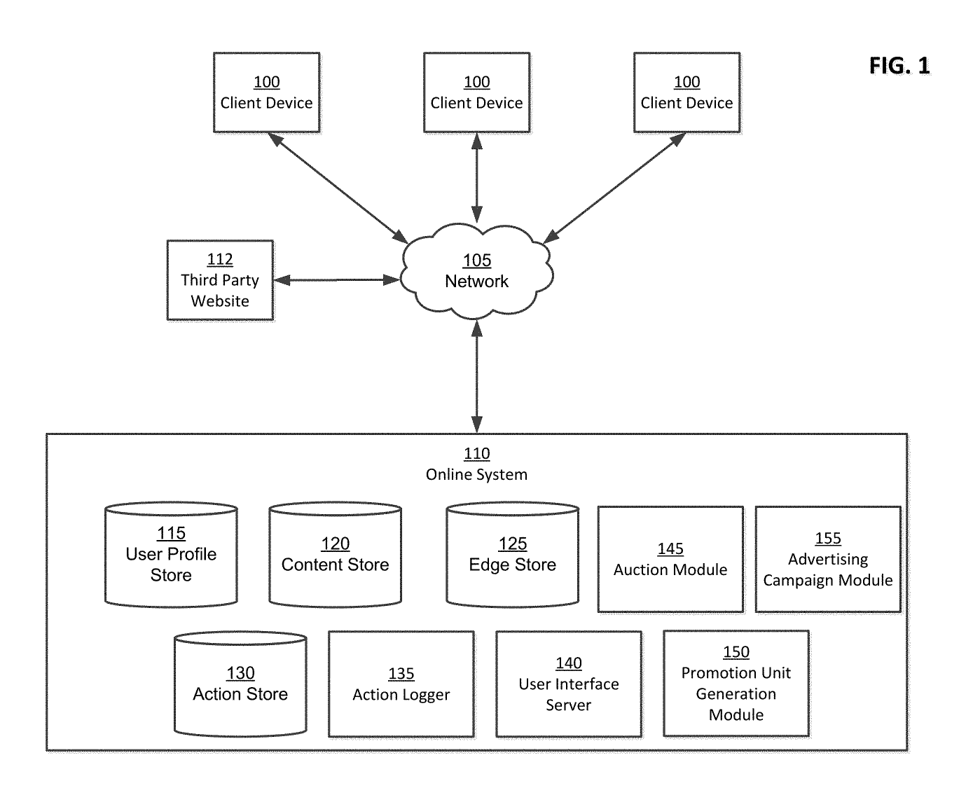

FIG. 1 is a high level block diagram of a system environment for an online system 110, according to one embodiment. The system environment shown by FIG. 1 comprises one or more client devices 100, a network 105, one or more third-party systems 112, and the online system 110. In alternative configurations, different and/or additional components may be included in the system environment. The embodiments described herein can be adapted to online systems that are not online systems.

The client devices 100 are one or more computing devices capable of receiving user input as well as transmitting and/or receiving data via the network 105. In one embodiment, a client device 100 is a conventional computer system, such as a desktop or laptop computer. Alternatively, a client device 100 may be a device having computer functionality, such as a personal digital assistant (PDA), a mobile telephone, a smartphone or another suitable device. A client device 100 is configured to communicate via the network 105. In one embodiment, a client device 100 executes an application allowing a user of the client device 100 to interact with the online system 110. For example, a client device 110 executes a browser application to enable interaction between the client device 100 and the online system 110 via the network 105. In another embodiment, a client device 100 interacts with the online system 110 through an application programming interface (API) running on a native operating system of the client device 100, such as IOS® or ANDROID™.

The client devices 100 are configured to communicate via the network 105, which may comprise any combination of local area and wide area networks employing wired or wireless communication links. In one embodiment, the network 105 uses standard communications technologies and protocols. For example, the network 105 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 105 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 105 may be represented using any suitable format, such as hypertext markup language (HTML) or extensible markup language (XML). In some embodiments, all or some of the communication links of the network 105 may be encrypted using any suitable technique or techniques.

One or more third party systems 112 may be coupled to the network 105 for communicating with the online system 110, which is further described below in conjunction with FIG. 1. In one embodiment, a third party system 112 is an application provider communicating information describing applications for execution by a client device 100 or communicating data to client devices 100 for use by an application executing on the client device. In other embodiments, a third party system 112 provides content or other information for presentation via a client device 100. A third party website 112 may also communicate information to the online system 110, such as advertisements, content, or information about an application provided by the third party website 112.

The online system 110 shown in FIG. 1 includes a user profile store 115, a content store 120, an action logger 125, an action store 130, an edge store 135, a user interface server 140, an auction module 145, a promotion unit generation module 150, and an advertising campaign module 155. In other embodiments, the online system 110 may include additional, fewer, or different components for various applications. Conventional components such as network interfaces, security functions, load balancers, failover servers, management and network operations consoles, and the like are not shown so as to not obscure the details of the system architecture.

Each user of the online system 110 is associated with a user profile, which is stored in the user profile store 205. A user profile includes declarative information about the user that was explicitly shared by the user and may also include profile information inferred by the online system 110. In one embodiment, a user profile includes multiple data fields, each describing one or more attributes of the corresponding user of the online system 110. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 110 displayed in an image. A user profile in the user profile store 115 may also maintain references to actions by the corresponding user performed on content items in the content store 120 and stored in the action store 130.

The content store 120 stores objects that each represent various types of content. Examples of content types represented by an object include a page post, a status update, a photograph, a video, a link, a shared content item, a gaming application achievement, a check-in event at a local business, a brand page, or any other type of content. Online system users may create objects stored by the content store 120, such as status updates, photos tagged by users to be associated with other objects in the online system, events, groups, or applications. In some embodiments, objects are received from third-party applications or third-party applications separate from the online system 110. In one embodiment, objects in the content store 120 represent single pieces of content, or content “items.” Hence, users of the online system 110 are encouraged to communicate with each other by posting content items of various types of media through various communication channels. This increases the amount of interaction of users with each other and increases the frequency with which users interact within the online system 110.

One or more advertisement requests (“ad requests”) are included in the content store 120. An advertisement request includes advertisement content and a bid amount. The ad requests may be a page of an advertising campaign by an advertiser. The advertisement content is text, image, audio, video, or any other suitable data presented to a user. In various embodiments, the advertisement content also includes a landing page specifying a network address to which a user is directed when the advertisement is accessed, which may include a page on the online system 110. The bid amount is associated with an advertisement by an advertiser and is used to determine an expected value, such as monetary compensation, provided by an advertiser to the online system 110 if the advertisement is presented to a user, if the advertisement receives a user interaction, or based on any other suitable condition. For example, the bid amount specifies a monetary amount that the online system 110 receives from the advertiser if the advertisement is displayed and the expected value is determined by multiplying the bid amount by a probability of the advertisement being accessed. The advertising campaign may also specify a budget and duration to present advertisements associated with the advertising campaign. As the time specified in the advertising campaign proceeds, the bid amount for ad requests may be adjusted upwards or downwards based on the performance of the advertisement to pace the display of the advertisement to advertisers and increase the likelihood that the budget is effectively spent during the advertising campaign.

Additionally, an advertisement request may include one or more targeting criteria specified by the advertiser. Targeting criteria included in an advertisement request specify one or more characteristics of users eligible to be presented with content in the advertisement request. For example, targeting criteria are a filter to apply to fields of a user profile, edges, and/or actions associated with a user to identify users having user profile information, edges or actions satisfying at least one of the targeting criteria. Hence, the targeting criteria allow an advertiser to identify groups of users matching specific targeting criteria, simplifying subsequent distribution of content to groups of users.

In one embodiment, the targeting criteria may specify actions or types of connections between a user and another user or object of the online system 110. The targeting criteria may also specify interactions between a user and objects performed external to the online system 110, such as on a third party website 112. For example, the targeting criteria identifies users that have taken a particular action, such as sending a message to another user, using an application, joining a group, leaving a group, joining an event, generating an event description, purchasing or reviewing a product or service using an online marketplace, requesting information from a third-party website 112, or any other suitable action. Including actions in the targeting criteria allows advertisers to further refine users eligible to be presented with content from an advertisement request. As another example, targeting criteria may identify users having a connection to another user or object or having a particular type of connection to another user or object.

The action logger 125 receives communications about user actions internal to and/or external to the online system 110, populating the action store 130 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action store 130.

The action store 130 may be used by the online system 110 to track user actions on the online system 110, as well as actions on third party systems 112 that communicate information to the online system 110. Users may interact with various objects on the online system 110, and information describing these interactions is stored in the action log 120. Examples of interactions with objects include: commenting on posts, sharing links, and checking-in to physical locations via a mobile device, accessing content items, and any other interactions. Additional examples of interactions with objects on the online system 110 that are included in the action store 130 include commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action store 130 may record a user's interactions with advertisements on the online system 110 as well as with other applications operating on the online system 110. In some embodiments, data from the action store 130 is used to infer interests or preferences of a user, augmenting the interests included in the user's user profile and allowing a more complete understanding of user preferences.

The action store 130 may also store user actions taken on a third party system 112, such as an external website, and communicated to the online system 110. For example, an e-commerce website that primarily sells sporting equipment at bargain prices may recognize a user of an online system 110 through a social plug-in enabling the e-commerce website to identify the user of the online system 110. Because users of the online system 110 are uniquely identifiable, e-commerce websites, such as this sporting equipment retailer, may communicate information about a user's actions outside of the online system 110 to the online system 110 for association with the user. Hence, the action store 130 may record information about actions users perform on a third party system 112, including webpage viewing histories, advertisements that were engaged, purchases made, and other patterns from shopping and buying.

In one embodiment, an edge store 135 stores information describing connections between users and other objects on the online system 110 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 110, such as expressing interest in a page on the online system, sharing a link with other users of the online system, and commenting on posts made by other users of the online system.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 110, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 135 also stores information about edges, such as affinity scores for objects, interests, and other users. Affinity scores, or “affinities,” may be computed by the online system 110 over time to approximate a user's affinity for an object, interest, and other users in the online system 110 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 135, in one embodiment. Alternatively, each interaction between a user and a specific object is stored as a separate edge. In some embodiments, connections between users may be stored in the user profile store 115, or the user profile store 115 may access the edge store 135 to determine connections between users.

The user interface server 140 links the online system 110 via the network 105 to the one or more client devices 100, as well as to the one or more third party systems 112. The user interface server 140 serves web pages, as well as other web-related content, such as JAVA®, FLASH®, XML and so forth. The user interface server 140 may receive and route messages between the online system 110 and the client device 100, for example, instant messages, queued messages (e.g., email), text messages, short message service (SMS) messages, or messages sent using any other suitable messaging technique. A user may send a request to the user interface server 140 to upload information (e.g., images or videos) that are stored in the content store 120. Additionally, the user interface server 140 may provide application programming interface (API) functionality to send data directly to native client device operating systems, such as IOS®, ANDROID™, WEBOS® or RIM®.

The user interface server 140 generates user interfaces, such as web pages, with content from the online system 110. The user interfaces are displayed to the user through a client device 100 and network 105. The user interfaces provided by the user interface server 140 allows a user to generate content items and interact with content items stored by the content store 120. For example, a user interface may provide a method for a user provide text, pictures, videos, links, and advertisements to be used to generate content items. The user interface server 140 configures a user interface based on the client device 100 used to present it. For example, a user interface for a smartphone with a touchscreen may be configured differently from a user interface for a web browser on a computer.

In one embodiment, the user interface server 140 identifies stories likely to be of interest to a user through a “newsfeed” presented to the user. A story presented to a user describes an action taken by an additional user connected to the user and identifies the additional user. In some embodiments, a story describing an action performed by a user may be accessible to users not connected to the user that performed the action. The user interface server 140 may generate stories for presentation to a user based on information in the action store 130 and in edge store 125 or may select candidate stories included in content store 120. One or more of the candidate stories are selected and presented to a user by the user interface server 140.

For example, the user interface server 140 receives a request to present one or more stories to an online system user. The user interface server 140 accesses one or more of the user profile store 115, the content store 120, the action store 130, and the edge store 125 to retrieve information about the identified user. For example, stories or other data associated with users connected to the identified user are retrieved. The retrieved stories or other data is analyzed by the user interface server 140 to identify content likely to be relevant to the identified user. For example, stories associated with users not connected to the identified user or stories associated with users for which the identified user has less than a threshold affinity are discarded as candidate stories. Based on various criteria, the user interface server 140 selects one or more of the candidate stories for presentation to the identified user.

In various embodiments, the newsfeed manager user interface server 140 presents stories to a user through a newsfeed, which includes a plurality of stories selected for presentation to the user. The newsfeed may include a limited number of stories or may include a complete set of candidate stories. The number of stories included in a newsfeed may be determined in part by a user preference included in the user profile store 115. The user interface server 140 may also determine the order in which selected stories are presented via the newsfeed. For example, the user interface server 140 determines that a user has a highest affinity for a specific user and increases the number of stories in the newsfeed associated with the specific user or modifies the positions in the newsfeed where stories associated with the specific user are presented.

The user interface server 140 may also account for actions by a user indicating a preference for types of stories and selects stories having the same, or similar, types for inclusion in the newsfeed. Additionally, the user interface server 140 may analyze stories received by online system 120 from various users and obtains information about user preferences or actions from the analyzed stories. This information may be used to refine subsequent selection of stories for newsfeeds presented to various users.

The auction module 145 selects additional content for insertion into the feed of stories for a viewing user. In other examples, the content selected by the auction module is added to other portions of a page for the user, rather than to a feed, such as in a side panel accompanying the newsfeed or in other parts of a page of the online system in which a limited set of content may be presented to the viewing user.

The content selected by the auction module 145 generally includes content that is selected to provide an additional benefit to the online system 110 in addition to the content selected for the user in the newsfeed. In one embodiment, the auction module 145 provides page promotion units when a user is eligible for a page promotion unit, and in other embodiments the auction module 145 executes an auction between different types of content, which may include page promotion units. The different types of content included in the auction module 145 may include page promotion units, recommendation units, and advertisements. Each of these types of content may compete with one another for placement to a viewing user. Since each of these content types takes some of the limited space in the user's display, the auction is used to select which of these is most valuable to the online system for presentation to the user. The auction module 145 may query the content store 120 for ad requests for which the viewing user meets the targeting criteria, and adds these ad requests to the auction. To add recommendation units and promotion units to the auction, these may also be scored as described below and similarly added to the auction. After the auction, the selected content is presented to the user in the space for which the auction was run.

An online system provides one or more recommendation units to its users to increase user interaction with the online system. A recommendation unit suggests one or more actions a user viewing the recommendation unit to increase the viewing user's interaction with the online system. For example, a recommendation unit provides a suggestion for the viewing user to establish a connection with another user as well as a link enabling the user to do so. In other examples, a recommendation unit encourages the viewing user to invite a friend to an event, identify a friend in a photo, join a group, or perform another suitable action with the online system. Each recommendation unit is associated with a score based on a value of the viewing user interacting with the recommendation unit (i.e., “converting” the recommendation unit by performing the recommended action) and/or on the likelihood that the viewing user will convert the recommendation unit. The score may be based on prior interaction with recommendation units by the viewing user, other users to whom the viewing user is connected, a probability of the viewing user interacting with the recommendation unit, or other criteria. Determination of a score for a recommendation unit is further described in U.S. patent application Ser. No. 13/549,080, filed on Jul. 13, 2012, which is hereby incorporated by reference in its entirety. The score is used by the auction module 145 in the auction to select one or more recommendation units to send to a user based at least in part on this score.

Page promotion units are provided to users to encourage users, who have a relationship to an entity, brand, or other specialized page, to advertise the page to other users of the online system. In one embodiment, the pages that may be used for generating a page promotion unit may comprise any page other than a user profile page for the user, and may include profile pages for companies, public figures, stores, venues, various groups, and so forth. In this sense, the page promotion unit can be considered a type of recommendation unit that encourages a user to advertise for a page. When a user requests a page, the auction module 145 determines whether a user is eligible for a page promotion unit, and if eligible, adds the page promotion unit to the auction. When the page promotion unit wins the auction, the auction module 145 may request generation of a particular page promotion unit from the promotion unit generation module 150. In other examples, rather than auctioning the page promotion unit as a type (i.e., without the contents of the page promotion unit), the promotion unit generation module 150 generates one or more candidate page promotion units for one or more pages associated with the user, each of which is individually scored and entered to the auction. In addition to pages on the online system, the pages used for a page promotion unit may also include pages on another website or system associated with a user or previously advertised by the user on the online system 110.

In addition to placement in the auction, the page promotion units may also be presented via other channels of the social networking system, such as by notification or when a user views or interacts with an eligible page to be promoted by the user.

To be eligible for a page promotion unit, the auction module 145 identifies pages associated with the user, and may request a candidate page promotion unit from promotion unit generation module 150 for each page. In some embodiments, the user may be eligible when the user is a page administrator for a page, and has permissions to manage or post content items to the page, advertise for the page, or otherwise be associated with permissions of the page in addition to a normal user's permissions. Eligibility for a page promotion unit may also be based on a user's prior activity with respect to the page or prior promotion (e.g., advertising) for the page. For example, a user may not be eligible if a user has recently advertised for the page, but eligible if no advertisements have been run for the page in the last month. In some embodiments, the user is not eligible if the page currently has an advertising request active for the page. In other examples, the auction module 145 determines eligibility for the page based on activity and content associated with the page. In various examples, the page is not eligible when it does not have sufficient content (i.e., fewer than a threshold number of content items), the page does not have any images associated with the page, or the page has no description or other metadata.

Each page promotion unit may also be scored for inclusion in the auction. The score for the page promotion unit may be based on the likelihood that a viewing user will interact with the page promotion unit, the expected value of any advertising campaigns provided by the viewing user when interacting with the page promotion unit, the content included in the page promotion unit, and other factors for valuing the page promotion unit.

The promotion unit generation module 150 generates the page promotion unit for a viewing user. After identifying the viewing user and the page that the viewing user may advertise (i.e., the page offered for promotion to the viewing user), the promotion unit generation module generates proposed information for a campaign to be selected by the viewing user. The page promotion unit may include a sample advertisement for the page for display to the viewing user and may also, or alternatively, include suggested operational parameters for a campaign that places an advertisement to other users. The sample advertisement provides information to the viewing user reflecting a possible advertisement that the viewing user may use to promote the advertisement and the operational parameters propose the parameters for the campaign. The page promotion unit may also include an expected reach for the campaign. Thus the page promotion unit may show any combination of: the proposed content to be promoted, how it will be promoted, and may include the expected results (i.e., reach) of the campaign.

The sample advertisement may include content from the promoted page, and may include advertising content previously used by the page in a prior advertising request. This content may include a description of the page, a cover or banner of the page, and information from one or more content items of the page. For example, the sample advertisement may include a title, body, image, and other elements for the advertisement. Further example methods of generating a sample advertisement are provided in U.S. application Ser. No. 14/102,794, titled “Simplified Creation of Advertisements for Objects Maintained by an Online System,” the contents of which are hereby incorporated by reference in their entirety. The particular content selected for the sample advertisement may also be based on the viewing user. For example, the viewing user's relationship to the content items may affect which content related to the page is selected for the page promotion unit. The promotion unit generation module 150 may select such content items based on a viewing user's affinity for the content items posted at the page, or may select content items based on a viewing user's activity with respect to the page. For example, the promotion unit generation may include content items that were generated or posted by the viewing user, or content items that were recently added by to the page, or that relate to topics or interests of interest to the viewing user.

The promotion unit generation module 150 may also generate and provide operational parameters for the campaign and expected reach and interaction information for the viewing user. The promotion unit generation module 150 generates operational parameters such as a budget to be used in the campaign based on characteristics of the viewing user who may place the initiate the campaign (e.g., the page administrator). Additional operational parameters may be determined based on characteristics of the page or content to the promoted by the page promotion unit. The budget for the campaign may be suggested as an operational parameter based on characteristics of the user, such as prior budgets initiated by the user, currency, country, and number of users connected to the advertised page. This suggestion may be determined based on a machine learned model that predicts advertising spend based on these characteristics of a user that uses the actually-selected advertising budget of campaigns as an output of the model. Since the number of campaigns by a given user may be relatively small, the model may be trained based on user characteristics and campaign parameters of prior campaigns placed at the online system 110.

In addition or as an alternative, the machine model may also determine a suggested budget based on an expected value. For example, the machine model may predict a user's likelihood to promote a page given a suggested budget. Based on the user's likelihood to promote the page and the value of the suggested budget, the suggested budget may be determined to maximize expected value. For example, the suggested budget may be provided to the model along with user characteristics and used to predict the likelihood that a user will promote the page with that suggested budget. A variety of suggested budgets may be determined along with accompanying likelihoods of promoting the page to determine the budget to suggest in the page promotion unit.

Additional suggested operational parameters may also be generated based on characteristics of the page to be promoted by the page promotion unit. Such additional, or alternative, operational parameters include targeting criteria for an audience to view the advertisement. The targeting criteria may specify a location or interests of users to be targeted with the promotion. For example, the suggested operational parameters for the promotion unit may suggest targeting users in Buffalo, N.Y. with an interest in hockey. The suggested operational parameters may be based on characteristics of the page, such as interests or locations associated with the page, as well as on users that are associated with the promoted page. In one example, a location is determined based on a location associated with the page, a geographical distribution of users associated with the page, the viewing user's location (e.g., who will be deciding to place the page promotional unit), and previous campaign targeting locations. In another example, interests may be suggested for targeting criteria based on interests associated with the page (e.g., topics associated with the page) or based on interests of users associated with the page. These additional operational parameters may also be to be suggested for the promotion may be determined by a trained computer model. The computer model may be trained on prior campaigns placed at the online system 110 related to the page or related to other pages in the online system 110.

The promotion unit generation module 150 may also determine an estimated reach for a campaign initiated from the page promotion unit. The estimated reach is a prediction of the number of users that will view and interact with the content based on a suggested targeting criteria and budget for the page promotion unit. Thus, the reach may demonstrate the expected benefit from placing an advertisement of a proposed budget to a designated group of users. The expected reach may be determined by various means, and as a simple example may determine the average price to place content to members of the targeted group divided by the budget. An interaction rate may also be determined based on the average interaction rate of the users, in which case the estimated reach may also be used to predict the frequency that targeted users will perform a desired action of the promotion. The expected reach for an advertisement may be based on a desired action associated with the content promoted by the page promotion unit. For promotion units that include suggested content, the action may include interacting with or clicking on the suggested content by users targeted by the advertisement. Certain promotion units may promote interactions with the page, such as users “liking,” “connecting with” or “becoming a fan” of the page. These promotion units may use this action (e.g., liking) as the desired action for estimating reach.

Thus, the page promotion unit may include various characteristics of the proposed campaign for the viewing user to promote the page, such as the content to be promoted, operational characteristics, and reach of the campaign. The promotion unit generation module 150 may generate promotion units having any combination of these suggested characteristics of the proposed campaign. By including the various characteristics of a campaign to a viewing user, the viewing user may easily initiate a campaign suggested by the page promotion unit with the operational and other parameters suggested by the page promotion unit. As these suggested operational parameters are predicted by a computer model and particularized to the user and the promoted page, the page promotion units automate the promotion and selection process for the user in placing a campaign. As a result, different content and operational parameters may be suggested to different administrators of the page, according to each administrator's previous campaigns and according to the prior operational parameters (e.g., budgets).

The page promotion unit also includes an interface for the user to initiate an advertising campaign (i.e., with one or more ad requests) from the promotion unit. When the user interacts with the interface to initiate the advertising campaign, the advertising campaign module 155 provides an interface for the user to select content and parameters of the advertising campaign. The advertising campaign module provides a purchase flow for the advertiser to select targeting criteria, a budget, advertising content, and other details of the advertising campaign. After the user interacts with the advertising campaign module and initiates the advertising campaign, the advertising campaign and its related ad requests are added to the content store 120 and may be selected by the auction module 145 to be provided to other users of the online system 110.

The advertising campaign module 155 may use the promotion unit to prepopulate the advertising content for the advertisement. That is, the sample ad provided in the promotion unit is used in some embodiments as the advertisement for an advertiser to initiate the advertising campaign. The advertising campaign module 155 may also automatically provide targeting criteria and other details to the user, for example based on a previous advertising campaign initiated by the viewing user. In other examples, the advertising campaign module 155 generates recommended targeting criteria, for example as described in U.S. application Ser. No. 14/102,794, incorporated by reference above.

The advertising campaign module 155 may also automatically place an advertising campaign when a user interacts with the page promotion unit. For example, a campaign may be initiated using content in the page promotion unit along with the suggested operational parameters, such as budget and targeting criteria. The campaign may then be automatically created using these parameters and begin to provide content to users. Since the suggested parameters reflect user and page characteristics applied to the machine learned model, the suggested parameters are likely to reflect the user's actual likely preferences for a campaign, and seamlessly propose and create ad campaigns from the page promotion units.

When a viewing user is presented with the page promotion unit, the user may thus interact with the page promotion unit to promote the page associated with the viewing user, and interact with the page provided by the advertising campaign module to initiate an ad campaign quickly. Because the ad content of the advertising campaign can match the sample in the ad promotion unit and operational parameters, targeting criteria and other details can be automatically generated and recommended to the user, the user can create an advertisement campaign as suggested by the page promotion unit quickly and easily.

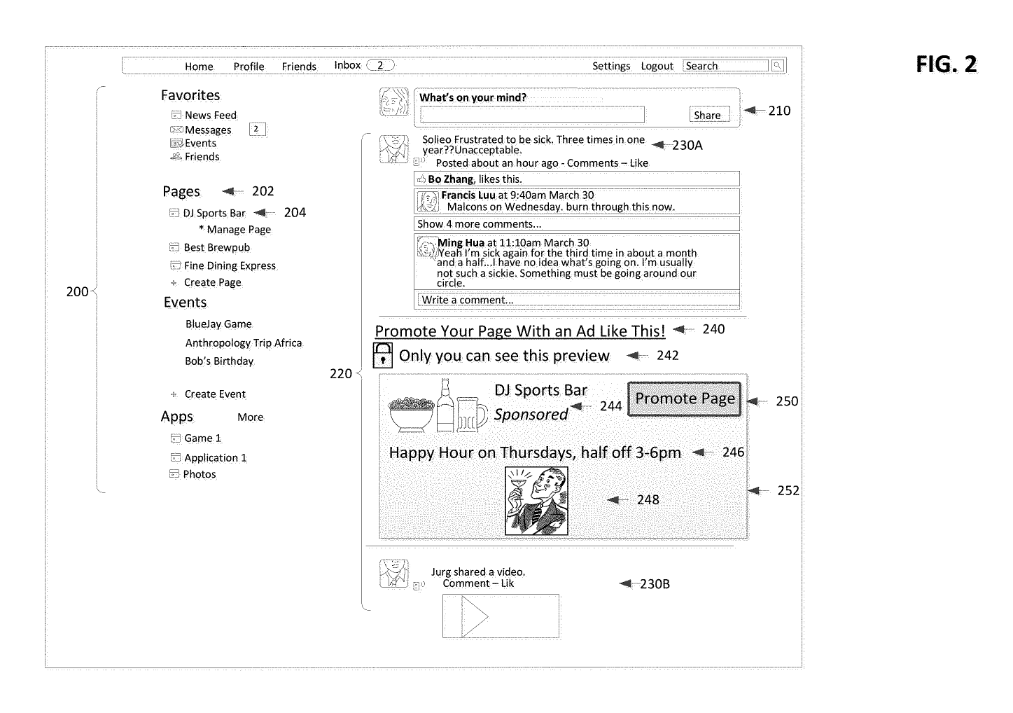

FIG. 2 illustrates a sample user interface of a feed of stories 220 including a page promotion unit 240, according to one embodiment. The user interface may include a sidebar 200, a posting interface 210, and the feed of stories 220.

The sidebar 200 provides information to the user and may provide navigation to other pages and areas of the online system. Of particular interest, the sidebar may include various information for the user, including a set of pages 202 for the user, of which the user may be an administrator. In this example, the viewing user is a page manager of “DJ Sports Bar” 204, and the sidebar may indicate an option for the user to manage that page.

The posting interface 210 provides an interface for a user to enter status or other information to the online system to post a new content item. The posting interface 210 may also allow a user to enter video, images, a location, and other information related to the user for display to other users of the online system 210.

The feed 220 provides a list of stories 230 for the user, such as a status update 230A and a video 230B, which may be selected from among many content items or stories related to other users of the online system 110 as described above. In addition, the feed of stories 220 includes a page promotion unit 240 including a sample advertisement 252. The page promotion unit 240 includes a description of the page promotion unit, for example to indicate to the user that the viewing user may promote the page via the page promotion unit 240, and including an indication 242 that the page promotion unit provides a preview for the viewing user of the sample advertisement 252. In this example, the sample advertisement 252 shows the title 244 of the page that may be advertised by the page promotion unit 240, as well as an image 248 and description 246 of a content item associated with the page. In this example, the content item and description may be retrieved from a content item on the page that promoted the page. This content may have been previously advertised by the page, or may be related to the viewing user, or otherwise generated as indicated above.

As shown here, the page promotion unit 240 provides an interface 250 for the viewing user to promote the page associated with the viewing user. When the user interacts with the promotion interface 250, the user is directed to an ad creation flow to generate an advertising campaign based on the user's selection. In one example, the user is directed to another page to confirm the advertising content, targeting criteria, and other details of the ad. In other examples, a pop-up or other display may be shown on the same page as the feed 220. The pop-up may display an interface for selecting the targeting criteria, bid, and/or budget to initiate the advertising campaign, such that the user can initiate a campaign based on the sample advertisement 252 from the newsfeed page itself.

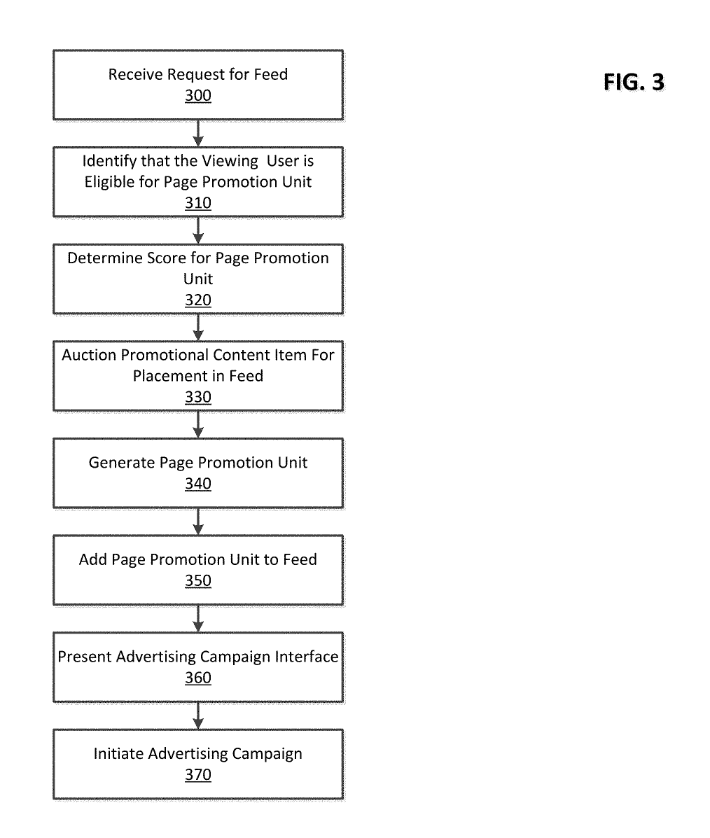

FIG. 3 illustrates a sample flow for displaying a page promotion unit and initiating an advertising campaign from the page promotion unit, according to one embodiment. The example steps in this flow may be performed by components of the online system, such as the user interface server 140, the auction module 145, the promotion unit generation module 150, and the advertising campaign module 155.

The online system 110 receives a request 300 for a feed from a client device 100. In alternatively, rather than a feed, the online system 110 identifies another location or slot in a user interface in which a page promotion unit may be inserted. Next, the viewing user requesting the feed or other location for the promotion unit is determined and the online system determines whether the user is eligible for a page promotion unit. As indicated above, the user may be eligible when the user has an administrative role with respect to a page, or has previously advertised for the page, among other eligibility criteria that may be applied. In some examples, a score for the page promotion unit is determined 320 and auctioned 330 to determine whether a page promotion unit or another type of content (such as an ad or a recommendation unit) will be presented in the feed or slot. After determining that the page promotion unit will be presented to the user, the page promotion unit may be generated 340. The content of the page promotion unit may be generated 340 prior to the auction, in which case the score may be based on the content of the page promotion unit itself. In other examples, the page promotion unit may be presented without an auction for other types of content.

To generate the page promotion unit 340, the online system 110 may analyze prior advertising requests or content items associated with the page to add content to the sample advertisement for the page promotion unit. Once the sample advertisement is added to the page promotion unit, the page promotion unit is added 350 to the feed or slot along with an interface element for the user to initiate an advertising campaign. Once the user interacts with the page promotion unit, an advertising campaign interface is presented 360 to the user for the user to provide details on the advertising campaign for the user to confirm the targeting criteria, advertising content, budget, and any other details for the advertising campaign. The advertising campaign is then initiated 370 and the advertisements may be provided to other users of the online system 110.

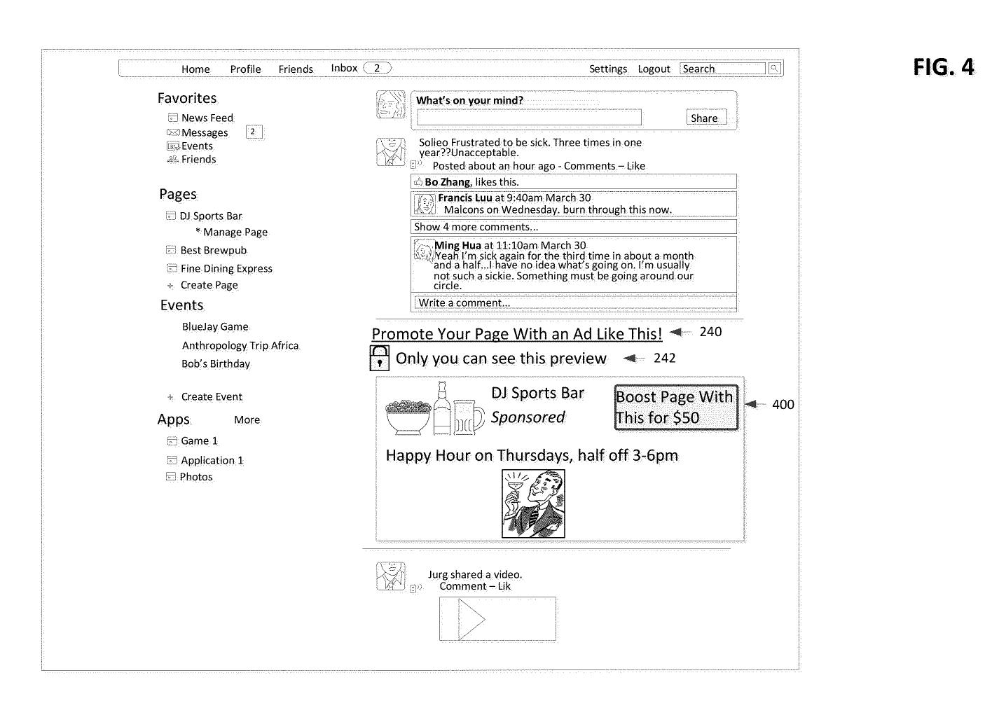

FIG. 4 illustrates a sample user interface of a feed of stories 220 including a page promotion unit 400 according to one embodiment. In this example, the page promotion unit includes a suggested campaign parameter specifying a budget for a campaign. In this example, the viewing user may also view and interact with the page promotion unit to initiate the campaign using the page promotion unit 400 to initiate a promotion having the suggested campaign parameters.

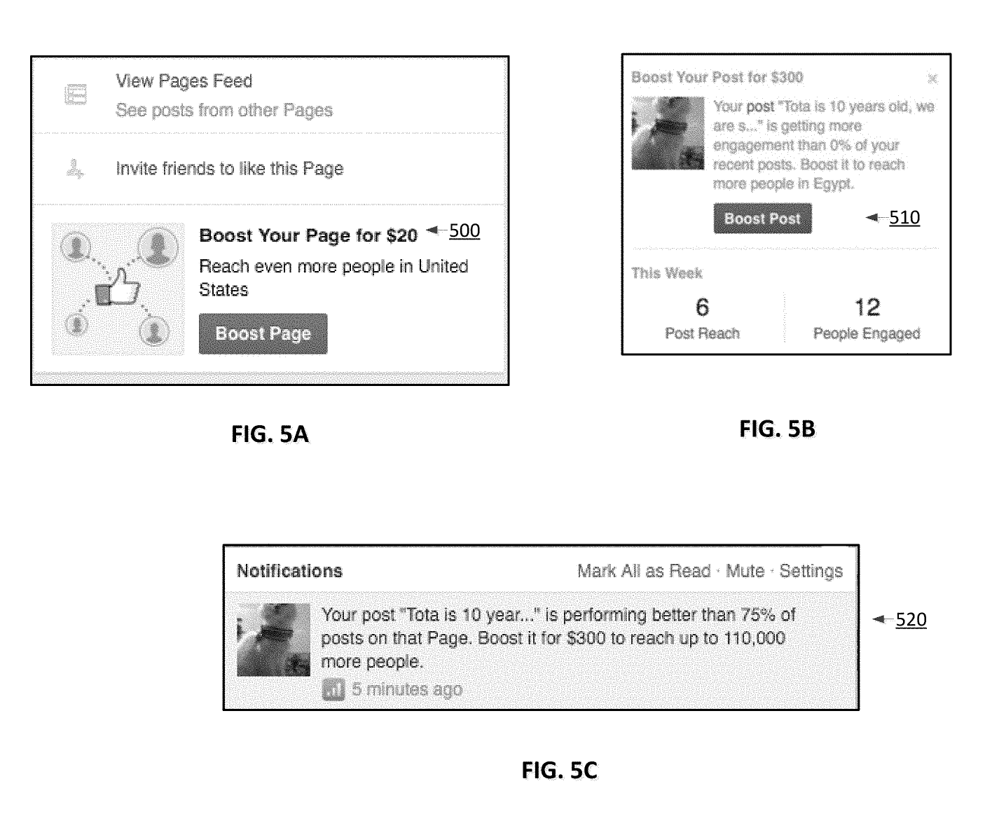

FIGS. 5A-5C illustrate sample user interfaces for page promotion units according to additional embodiments. The sample user interfaces shown in FIGS. 5A-5C illustrate page promotion units with varying operational parameters and presented in different portions of a user interface. FIG. 5A shows a page promotion unit 500 that includes a suggested location for the targeting criteria of the promotion. The page promotion unit 500 also specifies a budget of $20 for the campaign. The page promotion unit 500 may be displayed, for example, when a user interacts with a page administered by the viewing user, for example when the viewing user requests to view other content of the page. In this example, the user may interact with the “Boost Page” interface to initiate a campaign to promote the page, for example to provide the page to additional users in the campaign. FIG. 5B shows a page promotion unit 510 to boost an individual post. The promotion unit generation module 150 may identify a post to boost based on characteristics of a post, such as its relative interaction compared to other posts associated with the page and based on the post's current reach and engagement. In this example, suggested operational parameters for a campaign to boost the post in FIG. 5B are displayed to promote the post for a budget of $300 and to users with a location in Egypt. In the example of FIG. 5C, the page promotion unit 520 is displayed to a user as a notification. The notification may be based on user engagement with the post, and when the notification is triggered for the content item, a page promotion unit is generated to include operational parameters for the page. In this example, page promotion unit 520 includes a budget of 300 and an estimated reach of 110,000 users when a campaign is created with that budget. Thus, page administrators may be presented with page promotion units in a variety of interfaces to provide suggested operational parameters to promote a page or its content to other users. When interacting with the page promotion unit, a campaign may be automatically generated based on the interaction, or the suggested operational parameters may be provided in a campaign creation flow.

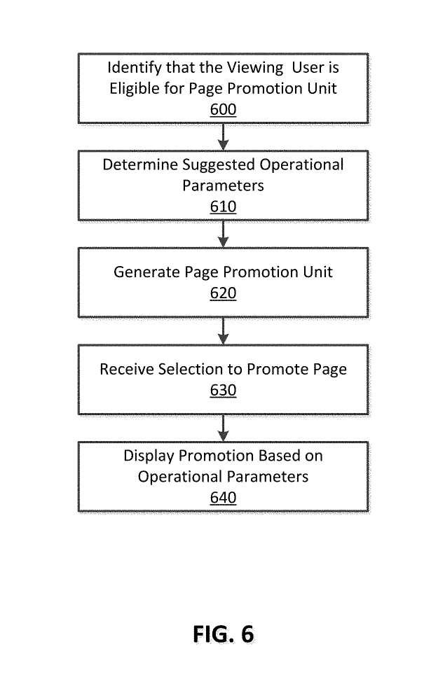

FIG. 6 illustrates a sample flow for displaying a page promotion unit and initiating an advertising campaign from the page promotion unit, according to one embodiment. This method may be performed, for example, by components of the online system 110. Initially, a user is identified as eligible to advertise for a page on the online system. The user may be identified 600 as eligible as discussed above, such as when the viewing user is an administrator for a page or has previously advertised for a page or posted content for a page as an administrator.

Next, suggested operational parameters are determined 610 based on characteristics of the viewing user and characteristics of the promoted page. The suggested operational parameters may include a budget and targeting criteria for a campaign. As discussed above, to determine 610 the suggested operational parameters, the user characteristics are applied to a computer model trained on prior campaigns. The user characteristics may describe the user's prior advertising campaigns, user currency, location, and number of fans of the page, among others. Targeting criteria may also be generated, for example based on a computer model accounting for a user's prior targeted users, topics associated with the page, user geographic distribution, among other examples as discussed above. From the suggested operational parameters, a page promotion unit is generated 620 to advertise the subject page. The page promotion unit may also include suggested content for the page or identify the content to be used in promoting the page. After presenting the page promotion unit to the viewing user, the viewing user may select an interface element to promote the page. When the selection is received 630, the page is promoted according to the operational parameters and the promotion is displayed 640 to other users. The campaign may be automatically initiated, or the viewing user may interact with a campaign creation flow to modify initial parameters based on the suggested operational parameters.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
identifying the viewing user as eligible to advertise for a page on the online system;
determining suggested operational parameters for an advertising campaign for the page based on characteristics of the viewing user;
generating a page promotion unit that displays the suggested operational parameters of the advertising campaign and includes an interface for the viewing user to initiate an advertising campaign;
receiving, from the client device, a selection from the viewing user to promote the page via the interface; and
displaying an advertisement to other users of the online system based on the suggested operational parameters.

2. The method of claim 1, wherein the suggested operational parameters include a budget for the ad campaign determined based on the user characteristics.

3. The method of claim 2, wherein the budget for the advertising campaign is determined with a machine learned model that applies user characteristics describing the viewing user's prior campaign budgets for the page.

4. The method of claim 2, further comprising determining a predicted reach of the advertising campaign based in part on the budget and including the predicted reach in the page promotion unit.

5. The method of claim 1, wherein one of the suggested operational parameters include targeting criteria for the ad campaign.

6. The method of claim 5, wherein the targeting criteria includes a location of users to be targeted with the ad campaign, the location based on characteristics of the page.

7. The method of claim 6, wherein the characteristics of the page include the location of users that interact with the page.

8. The method of claim 6, wherein the targeting criteria includes an a user interest to be targeted with the ad campaign, the user interest based on characteristics of the page.

9. The method of claim 1, wherein one or more of the suggested operational parameters are determined based on the user characteristics and one or more other suggested operational parameters are based on characteristics of the page.

10. The method of claim 1, wherein the page promotional unit is displayed with a content item to be promoted by the ad campaign, and the advertisement displays the content item.

11. A non-transitory computer-readable medium comprising instructions for execution by a processor for:
identifying the viewing user as eligible to advertise for a page on the online system;
determining suggested operational parameters for an advertising campaign for the page based on characteristics of the viewing user;
generating a page promotion unit that displays the suggested operational parameters of the advertising campaign and includes an interface for the viewing user to initiate an advertising campaign;
receiving, from the client device, a selection from the viewing user to promote the page via the interface; and
displaying an advertisement to other users of the online system based on the suggested operational parameters.

12. The computer-readable medium of claim 11, wherein the suggested operational parameters include a budget for the ad campaign determined based on the user characteristics.

13. The computer-readable medium of claim 12, wherein the budget for the advertising campaign is determined with a machine learned model that applies user characteristics describing the viewing user's prior campaign budgets for the page

14. The computer-readable medium of claim 12, further comprising determining a predicted reach of the advertising campaign based in part on the budget and including the predicted reach in the page promotion unit.

15. The computer-readable medium of claim 11, wherein one of the suggested operational parameters include targeting criteria for the ad campaign.

16. The computer-readable medium of claim 15, wherein the targeting criteria includes a location of users to be targeted with the ad campaign, the location based on characteristics of the page.

17. The computer-readable medium of claim 16, wherein the characteristics of the page include the location of users that interact with the page.

18. The computer-readable medium of claim 16, wherein the targeting criteria includes an a user interest to be targeted with the ad campaign, the user interest based on characteristics of the page.

19. The computer-readable medium of claim 11, wherein one or more of the suggested operational parameters are determined based on the user characteristics and one or more other suggested operational parameters are based on characteristics of the page.

20. The computer-readable medium of claim 11, wherein the page promotional unit is displayed with a content item to be promoted by the ad campaign, and the advertisement displays the content item.
